(19) United States
(12) Patent Application Publication
(10) Pub. No.: US 2026/0161886 A1
(43) Pub. Date: Jun. 11, 2026

(54) GENERATING DYNAMIC TEMPLATES FOR INFORMATION IN DOCUMENTS

(71) Applicant: S&P Global Inc., New York, NY (US)

(72) Inventors: Anand Chavan, Fairfield, CT (US); Ryan Minogue, White Plains, NY (US); Chatar Pal, Toronto (CA); Kaushal Lahankar, New York, NY (US)

(21) Appl. No.: 18/972,440

(22) Filed: Dec. 6, 2024

(51) Int. Cl. G06F 40/186; G06F 40/169

(52) U.S. Cl. CPC G06F 40/186; G06F 40/169

(57) ABSTRACT

An illustrative embodiment provides a computer-implemented method. The method comprises using a processor set to collect ground truth data and historical documents for a number of entities. The processor set converts physical documents for the number of entities into a number of virtual documents. The processor set annotates positions for the data on the pages to generate a number of addresses. The processor set generates historical contexts based on the ground truth data, the historical documents, and the number of addresses. The processor set creates a dynamic template for a current document for an entity from the number of entities.

### BACKGROUND INFORMATION

### 1. Field

The present disclosure relates generally to generating dynamic templates for information in documents.

### 2. Background

Insight extraction from semi-structured and unstructured documents refers to the process of deriving meaningful information from text or data that lacks a rigid structure. Insight extraction involves analyzing and interpreting information from text data that lacks a standardized format or organization.

Semi-structured data such as emails or log files usually contain some identifiable structures like tags or metadata but lack a uniform format. In a similar fashion, unstructured data such as plain text from articles, social media posts, or customer feedback usually has minimal organization and requires advanced processing before it can be used for other purposes.

In this case, insight extraction in above mentioned contexts often involves using natural language processing (NLP) to analyze, categorize, and retrieve useful information to support decision-making, customer understanding, or trend identification.

### SUMMARY

An illustrative embodiment provides a computer-implemented method. The method comprises using a processor set to collect ground truth data and historical documents for a number of entities. The processor set converts physical documents for the number of entities into a number of virtual documents. The number of virtual documents includes pages with data from the historical documents. The processor set annotates positions for the data on the pages to generate a number of addresses. Each address represents a position of a datapoint from the data on a page from the pages. The processor set generates historical contexts based on the ground truth data, the historical documents, and the number of addresses. The historical contexts include metadata associated with datapoints from the data on the pages. The processor set creates a dynamic template for a current document for an entity from the number of entities. The dynamic template includes historical data from the historical documents and information extracted from the current document based on the historical contexts.

Another illustrative embodiment provides a computer system. The system comprises a processor set, a set of one or more computer-readable storage media, and program instructions stored on the set of one or more storage media to cause the processor set to perform operations comprising collecting ground truth data and historical documents for a number of entities; converting physical documents for the number of entities into a number of virtual documents, where the number of virtual documents comprises pages with data from the historical documents; annotating positions for the data on the pages to generate a number of addresses, where each address represents a position of a datapoint from the data on a page from the pages; generating historical contexts based on the ground truth data, the historical documents, and the number of addresses, where the historical contexts comprise metadata associated with datapoints from the data on the pages; and creating a dynamic template for a current document for an entity from the number of entities, where the dynamic template comprises historical data from the historical documents and information extracted from the current document based on the historical contexts.

Another illustrative embodiment provides a computer program product. The computer program product comprises a set of one or more computer-readable storage media, and program instructions stored in the set of one or more storage media to perform operations comprising using a processor set to collect ground truth data and historical documents for a number of entities; converting physical documents for the number of entities into a number of virtual documents, where the number of virtual documents comprises pages with data from the historical documents; annotating positions for the data on the pages to generate a number of addresses, where each address represents a position of a datapoint from the data on a page from the pages; generating historical contexts based on the ground truth data, the historical documents, and the number of addresses, where the historical contexts comprise metadata associated with datapoints from the data on the pages; and creating a dynamic template for a current document for an entity from the number of entities, where the dynamic template comprises historical data from the historical documents and information extracted from the current document based on the historical contexts.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a template management environment in accordance with an illustrative embodiment;

FIG. 3 depicts exemplary dynamic template in accordance with an illustrative embodiment;

FIG. 4 depicts a flowchart illustrating a process for generating dynamic templates in accordance with an illustrative embodiment;

FIG. 5 depicts a flowchart illustrating a process for generating dynamic templates for a current document in accordance with an illustrative embodiment; and

FIG. 6 is a block diagram of a data processing system in accordance with an illustrative embodiment.

### DETAILED DESCRIPTION

The illustrative embodiments recognize and take into account a number of considerations. For example, the illustrative embodiments recognize and take into account that semi-structured and unstructured data have different data formats. The illustrative embodiments recognize and take into account that it is hard to compare and contrast across different formats or unify model development when building machine learning models using data with different data formats or organizations.

The illustrative embodiments recognize and take into account that the diversity of data format for semi-structured and unstructured data requires sophisticated natural language processing techniques to accurately capture the meaning and context within the text.

The illustrative embodiments also recognize and take into account that the above mentioned document standardization problem can be decoupled from machine learning model development by leveraging document standardization into an internal representation that can be initialized for all data format.

Thus, illustrative embodiments of the present invention provide a computer implemented method, computer system, and computer program product for generating dynamic template for standardizing information obtained from documents in different format. The method comprises using a processor set to convert physical documents for the number of entities into a number of virtual documents. The number of virtual documents includes pages with data from the historical documents. The processor set annotates positions for the data on the pages to generate a number of addresses. Each address represents a position of a datapoint from the data on a page from the pages. The processor set generates historical contexts based on the ground truth data, the historical documents, and the number of addresses. The historical contexts include metadata associated with datapoints from the data on the pages. The processor set creates a dynamic template for a current document for an entity from the number of entities. The dynamic template includes historical data from the historical documents and information extracted from the current document based on the historical contexts.

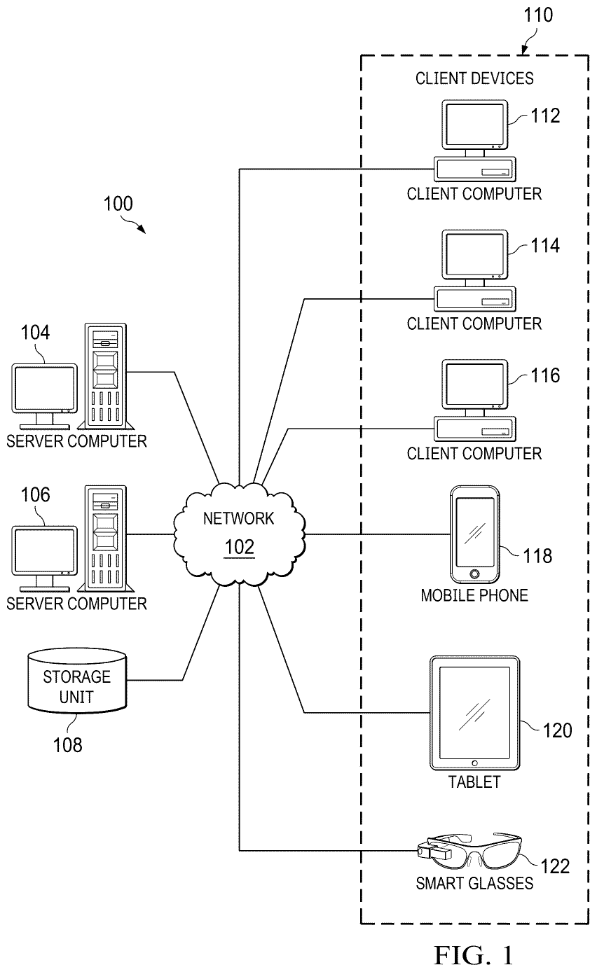

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

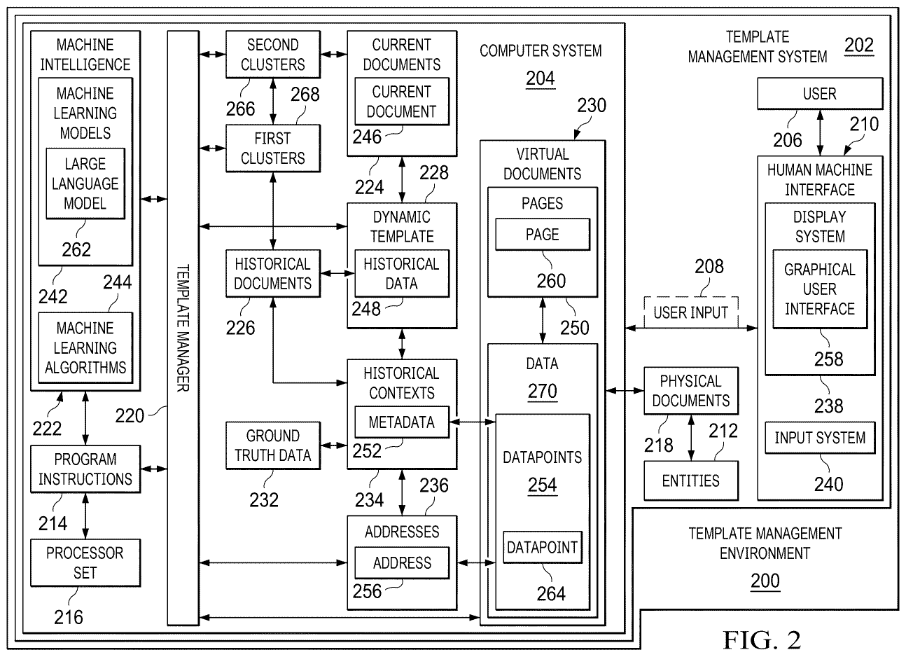

With reference now to FIG. 2, an illustration of a block diagram of a template management environment is depicted in accordance with an illustrative embodiment. In this illustrative example, template management environment 200 includes components that can be implemented in hardware such as the hardware shown in network data processing system 100 in FIG. 1.

In this illustrative example, template management system 202 in template management environment 200 extracts contexts from historical documents 226 from entities 212 and creates dynamic template 228 for current document 246. In this illustrative example, template management system 202 includes computer system 204 which includes template manager 220. Template manager 220 is located in computer system 204.

Template manager 220 can be implemented in software, hardware, firmware, or a combination thereof. When software is used, the operations performed by template manager 220 can be implemented in program instructions configured to run on hardware, such as a processor unit. When firmware is used, the operations performed by template manager 220 can be implemented in program instructions and data and stored in persistent memory to run on a processor unit. When hardware is employed, the hardware can include circuits that operate to perform the operations in template manager 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 216 in FIG. 2. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 222. Machine intelligence 222 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 222 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 222.

Machine intelligence 222 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer for extracting information from historical documents 226.

Machine learning models 242 involves using machine learning algorithms 244 to build computation models based on samples of data. The samples of data used for training are referred to as training data or training datasets. Machine intelligence 222 can make predictions without being explicitly programmed to make these predictions. Machine intelligence 222 can be used for training and retraining computation models for a number of different types of applications. These applications include, for example, medicine, financial services, healthcare, speech recognition, computer vision, or other types of applications.

In this illustrative example, machine learning models 242 can include a number of models. For example, machine learning models 242 can include a deep learning model such as large language model 262. In this illustrative example, large language model 262 is a type of machine learning model designed to understand, generate, and manipulate human language.

In this illustrative example, machine learning algorithms 244 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest.

In this illustrative example, template manager 220 receives physical documents 218 and ground truth data 232 for entities 212. In this illustrative example, entities 212 are recognizable units that can be identified within physical documents 218. For example, entities 212 can be companies, organizations, or people.

In addition, physical documents 218 are records that include information associated with entities 212. For example, physical documents 218 can include contracts ang agreements, financial records, human resources documents, legal documents, meeting notes and minutes, policies and manuals, intellectual property records, inventory and asset records, or any suitable documents associated with entities 212.

In this illustrative example, physical documents 218 can further be split into historical documents 226 and current documents 224. In this illustrative example, historical documents 226 are documents collected for entities 212 over time while current documents 224 are documents that are documents collected for entities 212 during a recent period of time specified by a user. In other words, template manager 220 receives both historical documents 226 and current documents 224 from physical documents 218.

Ground truth data 232 is accurate, reliable information for entities 212. For example, ground truth data 232 can include descriptions for historical data points from historical documents 226, values, and metadata associated with entities 212.

In this illustrative example, template manager 220 converts physical documents 218 into virtual documents 230. Virtual documents 230 are data structures stored in memory. In this example, virtual documents 230 include pages 250. Each page in page 250 can further include lines, tables, paragraphs, and metadata for each line. In this illustrative example, the lines are further divided into cells. The tables are further divided into headers, footers, and data. Headers for tables can be normalized for all virtual documents.

In this illustrative example, conversion of physical documents 218 into virtual documents 230 provides a standardized format for comparing content from physical documents 218. For example, physical documents 218 can include documents with different formats such as pdf format or HTML format. In this example, the conversion of physical documents 218 makes it easier to compare content from documents in different formats.

In this illustrative example, pages 250 in virtual documents 230 contain data 270 obtained from physical documents 218. In other words, pages 250 in virtual documents 230 contain data 270 received from both historical documents 226 and current documents 224.

In this illustrative example, template manager 220 can annotate positions for data 270 on pages 250 to generate addresses 236. Addresses 236 are position of datapoints 254 on pages 250. In this illustrative example, datapoints 254 are portions of data 270 shown on pages 250 in virtual documents 230. For example, datapoints 254 can include values such as individual words or collections of words, which are part of a line or a table from physical documents 218.

In this illustrative example, each datapoint in datapoints 254 can have a set of coordinates within pages 250. In other words, each datapoint in datapoints 254 has a set of coordinates within a page from pages 250 and addresses 236 can be generated based on the set of coordinates for datapoints 254. For example, datapoint 264 can be a word located on page 260 of pages 250.

In this illustrative example, the position, or the set of coordinates for the word represented by datapoint 264 within page 260 is annotated to generate address 256. In other words, address 256 represents position of datapoint 264 within page 260.

As depicted, each address in addresses 236 can be represented in a set of coordinates. In this illustrative example, each set of coordinates can include top coordinate, bottom coordinate, left coordinate, and right coordinate. In this illustrative example, the above mentioned four coordinates can also be used for inferring other information. For example, the difference between a top coordinate and a bottom coordinate can be used to determine height of datapoints. In another example, the difference between a left coordinate and a right coordinate can be used to determine if a given line contains headings or sub-headings. In this illustrative example, addresses 236 can further include information such as page numbers.

In this illustrative example, the annotation of positions for data 270 on pages 250 to generate addresses 236 can be performed manually or automatically. In this illustrative example, machine learning models 242 such as large language model 262 can be trained using historical data from historical documents 226 to determine positions of words or collections of words on pages 250. In other words, template manager 220 can utilize large language model 262 that is trained using historical data from historical documents 226 to annotate positions for data 270 on pages 250 in an autonomous manner.

In this illustrative example, historical documents 226 or portion of historical documents 226 may already be annotated. In this illustrative example, addresses for annotated historical documents can be identified using descriptions and values in the annotated historical documents. In this illustrative example, if multiple matches are found, the addresses can be ranked according to user-defined criteria.

In this illustrative example, template manager 220 can generate historical contexts 234 based on ground truth data 232, addresses 236, and historical documents 226. In this illustrative example, historical contexts 234 are contexts surrounding annotations in pages 250 from virtual documents 230.

Historical contexts 234 include metadata 252 associated with datapoints 254. In this illustrative example, metadata 252 is data that provides information for datapoints 254. For example, if datapoints 254 include a datapoint that is part of a table, metadata 252 can include information such as page number, table, row index, and column index for the above mentioned datapoint.

In this illustrative example, template manager 220 can use historical contexts 234 to generate dynamic template 228 for a current document from current documents 224. For example, dynamic template 228 can be generated for current document 246. In this example, dynamic template 228 can include historical data 248, which are obtained from historical documents 226 and information extracted from current document 246.

In this illustrative example, template manager 220 can generate dynamic template 228 in a number of ways. For example, template manager 220 can generate first clusters 268 for each historical document in historical documents 226 based on virtual documents 230. Each first cluster in first clusters 268 includes information associated with a number of datapoints from datapoints 254 for a historical document in historical documents 226.

Subsequently, template manager 220 can generate second clusters 266 for current document 246 by matching information associated with current document 246 and information associated with first clusters 268. As a result, dynamic template 228 can be generated for current document 246 based on first clusters 268 and second clusters 266.

In other words, first clusters 268 that contain information associated with historical documents 226 is matched with second clusters 266 that contain information associated with current document 246 to identify the most similar clusters. By such a method, similar information between current document 246 and historical documents 226 can be efficiently identified to be included in dynamic template 228. In this illustrative example, the generation of first clusters 268 and second clusters 266 as well as comparison between first clusters 268 and second clusters 266 can be performed using machine learning models 242.

In this illustrative example, first clusters 268 and second clusters 266 can be divided into different categories such as page, block, tables, table cells, lines, and paragraphs. In this illustrative example, matching logic is different for different categories. For example, cosine similarity analysis can be used for matching pages, table cells can be matched based on relative coordinates in the table, and paragraphs can be matched based on semantic matchings.

In this illustrative example, clusters that are matched based on first clusters 268 and second clusters 266 are matching clusters. In this example, the matching clusters can be scored and ranked. The scores are calculated by giving weightage to different parameters such as cell distance (left/right coordinates), row relative distance (top/bottom), or a cell/row index in a table or headers of cell.

For example, template manager 220 can perform a task to identify “weighted average interest rate for Term Loan B”, which is “7.6%” from a current document from current documents 224. In this illustrative example, ground truth data 232 and a virtual document for a historical document from historical documents 226 indicate that “weighted average interest rate for Term Loan B” is “6.19%”.

In this illustrative example, template manager 220 can generate clusters for similar words by matching descriptions and values for “weighted average interest rate for Term Loan B” in the current document with descriptions and values from datapoints 254 of virtual documents for historical documents 226. In this illustrative example, the clusters generated based on historical documents can be examples of first clusters 268 described above.

In this illustrative example, exemplary datapoints from historical documents 226 can be “description=“Weighted average interest rate for Term Loan B”, value=“6.19%”, date=“Dec. 3, 2022”, address (page_no, top, bottom, left, right)”

The output of generated clusters can be
<Match_Context1>:{page=>table=>matched_line, matched_column, prev lines, next lines, table headers, lines above headers, page headings, match_score, datapoint}; and
<Match_Context2>:{page=>table=>matched_line, matched_column, prev lines, next lines, table headers, lines above headers, page headings, match_score, datapoint}.

In this illustrative example, if <Match_Context1> and <Match_Context2> are found on the same table/page, the two clusters become part of one cluster <Cluster1>->{Match _Context1, Match _Context2}

In this illustrative example, template manager 220 can use the clusters generated based on historical documents to identify similar content and positions of the similar content in current document 246. In this illustrative example, template manager 220 uses above mentioned clusters to identify matching pages in current document 246 and derives matching context based on the matching pages. In this illustrative example, the matching context can be represented by a second set of clusters. In this illustrative example, the second set of clusters can be examples of second clusters 266.

In other words, template manager 220 can associate context around “weighted average interest rate for Term loan B” and “6.19%” from historical documents to “weighted average interest rate for Term loan B” and “7.6%” in current document 246 using above mentioned steps. As a result, dynamic template 228 can be generated to include “weighted average interest rate for Term loan B” and “7.6%” for current document 246.

In this illustrative example, users such as user 206 can interact with computer system 204 through user inputs to computer system 204. For example, computer system 204 can receive user input 208 that includes annotations for positions of data 270 on pages 250 and criteria for ranking addresses 236.

In this illustrative example, user input 208 can be generated by user 206 using human machine interface (HMI) 210. As depicted, human machine interface 210 includes display system 238 and input system 240. Display system 238 is a physical hardware system and includes one or more display devices on which graphical user interface 258 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 258 through user input 208 generated by input system 240. Input system 240 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view virtual documents 230, historical documents 226, current documents 224, and dynamic template 228 through graphical user interface 258 in display system 238. In addition, user 206 can provide user input 208 through graphical user interface 258.

In one illustrative example, one or more solutions are present that overcome a problem with extracting entities from documents. As a result, one or more technical solutions may provide an ability to increase the efficiency for standardizing documents with different formats and extracting information from documents in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which template manager 220 in computer system 204 enables efficient extraction of information in documents with different formats. In particular, template manager 220 transforms computer system 204 into a special purpose computer system as compared to currently available general computer systems that do not have template manager 220.

In the illustrative example, the use of template manager 220 in computer system 204 integrates processes into a practical application for standardizing documents and extracting information from documents with different formats because template manager 220 improves efficiency and accuracy of information extraction such that performance of computer system 204 can be increased. In other words, template manager 220 in computer system 204 is directed to a practical application of processes integrated into template manager 220 in computer system 204 that standardize documents with different formats and extract information from documents with different format in an accurate and efficient manner.

The illustration of template management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, template manager 220 can further perform post-processing of extracted data according to business domains. The post processing helps to standardizing values across different businesses and different countries. In this illustrative example, all extracted data is tagged to a standard predefined description in order to apply different business rules per tag. The business rules are executed before the extracted data is ready for customers. For example, a simple business rule can be “revenue should always be positive”.

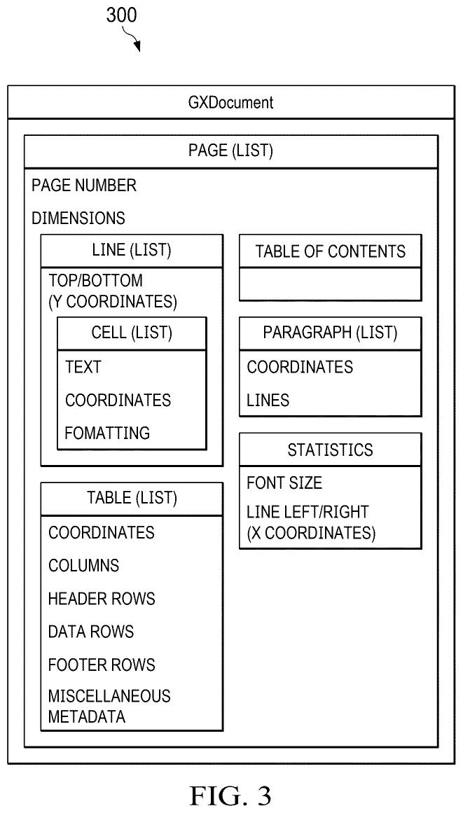

FIG. 3 depicts an exemplary dynamic template in accordance with an illustrative embodiment. In this illustrative example, dynamic template 300 can be an example of dynamic template 228 in FIG. 2.

As depicted, dynamic template 300 is a page and can be generated to include information extracted from documents. For example, dynamic template 300 can include lines, cells, tables, table of contents, paragraphs extracted from documents. In this illustrative example, dynamic template 300 can include statistics and metadata associated with content in documents.

The illustration of dynamic template 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, dynamic template 300 can be organized in a different manner and include different information as compared to the content shown in FIG. 3.

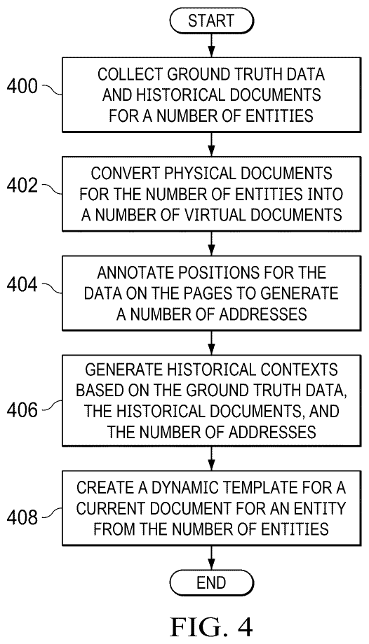

With reference now to FIG. 4, a flowchart illustrating a process for generating dynamic templates is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in template manager 220 in computer system 204 in FIG. 2.

The process begins by collecting ground truth data and historical documents for a number of entities (step 400). The process converts physical documents for the number of entities into a number of virtual documents (step 402). In step 402, the number of virtual documents includes pages with data from the historical documents.

The process annotates positions for the data on the pages to generate a number of addresses (step 404). In step 404, each address represents a position of a datapoint from the data on a page from the pages.

The process generates historical contexts based on the ground truth data, the historical documents, and the number of addresses (step 406). In this step, the historical contexts include metadata associated with datapoints from the data on the pages.

The process creates a dynamic template for a current document for an entity from the number of entities (step 408). In step 408, the dynamic template includes historical data from the historical documents and information extracted from the current document based on the historical contexts. The process terminates thereafter.

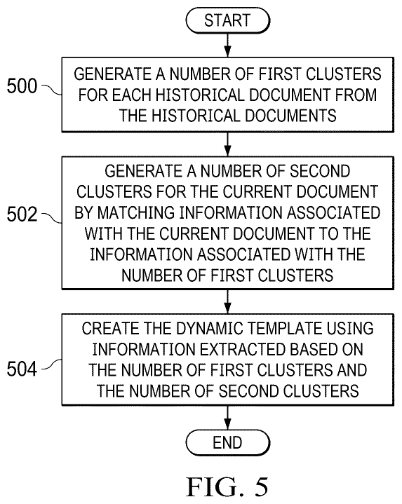

With reference now to FIG. 5, a flowchart illustrating a process for generating dynamic templates for a current document is shown in accordance with an illustrative embodiment. The process in this flowchart is an example of an implementation for step 408 in FIG. 4.

The process begins by generating a number of first clusters for each historical document from the historical documents (step 500). In step 500, each first cluster from the number of first clusters comprises information associated with a number of data points from data for a historical document.

The process generates a number of second clusters for the current document by matching information associated with the current document to the information associated with the number of first clusters (step 502).

The process creates the dynamic template using information extracted based on the number of first clusters and the number of second clusters (step 504). The process terminates thereafter.

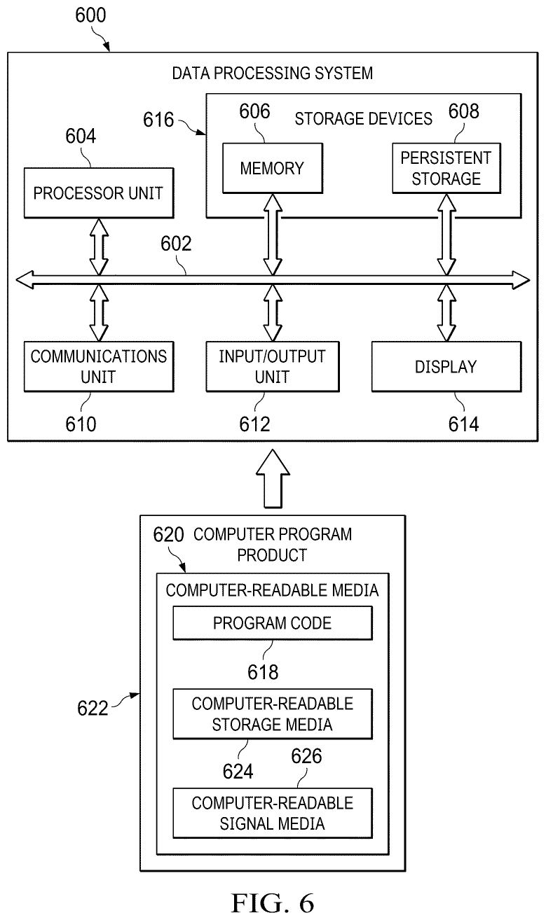

With reference now to FIG. 6, an illustration of a block diagram of a data processing system is depicted in accordance with an illustrative embodiment. Data processing system 600 may be used to implement server computer 104 and server computer 106 and client devices 110 in FIG. 1, as well as computer system 204 in FIG. 2. In this illustrative example, data processing system 600 includes communications framework 602, which provides communications between processor unit 604, memory 606, persistent storage 608, communications unit 610, input/output unit 612, and display 614. In this example, communications framework 602 may take the form of a bus system.

Processor unit 604 serves to execute instructions for software that may be loaded into memory 606. Processor unit 604 may be a number of processors, a multi-processor core, or some other type of processor, depending on the particular implementation. In an embodiment, processor unit 604 comprises one or more conventional general-purpose central processing units (CPUs). In an alternate embodiment, processor unit 604 comprises one or more graphical processing units (GPUs).

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer-readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a flash memory, a rewritable optical disk, a rewritable magnetic tape, or some combination of the above. The media used by persistent storage 608 also may be removable. For example, a removable hard drive may be used for persistent storage 608. Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer-usable program code, or computer-readable program code that may be read and executed by a processor in processor unit 604. The program code in the different embodiments may be embodied on different physical or computer-readable storage media, such as memory 606 or persistent storage 608.

Program code 618 is located in a functional form on computer-readable media 620 that is selectively removable and may be loaded onto or transferred to data processing system 600 for execution by processor unit 604. Program code 618 and computer-readable media 620 form computer program product 622 in these illustrative examples. In one example, computer-readable media 620 may be computer-readable storage media 624 or computer-readable signal media 626.

In these illustrative examples, computer-readable storage media 624 is a physical or tangible storage device used to store program code 618 rather than a medium that propagates or transmits program code 618. Computer-readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 618 may be transferred to data processing system 600 using computer-readable signal media 626. Computer-readable signal media 626 may be, for example, a propagated data signal containing program code 618. For example, computer-readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method, comprising:
collecting, by a processor set, ground truth data and historical documents for a number of entities;
converting, by the processor set, physical documents for the number of entities into a number of virtual documents, wherein the number of virtual documents comprises pages with data from the historical documents;
annotating, by the processor set, positions for the data on the pages to generate a number of addresses, wherein each address represents a position of a datapoint from the data on a page from the pages;
generating, by the processor set, historical contexts based on the ground truth data, the historical documents, and the number of addresses, wherein the historical contexts comprise metadata associated with datapoints from the data on the pages; and
creating, by the processor set, a dynamic template for a current document for an entity from the number of entities, wherein the dynamic template comprises historical data from the historical documents and information extracted from the current document based on the historical contexts.

2. The computer-implemented method of claim 1, wherein the generating, by the processor set, a dynamic template for a current document for an entity from the number of entities comprises:
generating, by the processor set, a number of first clusters for each historical document from the historical documents, wherein each first cluster from the number of first clusters comprises information associated with a number of data points from data for a historical document;
generating, by the processor set, a number of second clusters for the current document by matching information associated with the current document to the information associated with the number of first clusters; and
creating, by the processor set, the dynamic template using information extracted based on the number of first clusters and the number of second clusters.

3. The computer-implemented method of claim 1, wherein the ground truth data comprises descriptions, values, and metadata associated with datapoints from the historical documents.

4. The computer-implemented method of claim 1, wherein the positions for datapoints on the pages comprises top coordinates, bottom coordinates, left coordinates, and right coordinates.

5. The computer-implemented method of claim 1, wherein each page from the pages comprises lines, tables, paragraphs, and metadata for each line based on the data from the historical documents.

6. The computer-implemented method of claim 1, wherein the positions for the data on the pages are annotated manually by users through user interface.

7. The computer-implemented method of claim 1, wherein the positions for the data on the pages are annotated autonomously based on the historical documents using a machine learning model.

8. The computer-implemented method of claim 1, wherein the number of virtual documents is stored in memory.

9. A computer system, comprising:
a processor set;
a set of one or more computer-readable storage media; and
program instructions stored on the set of one or more storage media to cause the processor set to perform operations comprising:
collecting ground truth data and historical documents for a number of entities;
converting physical documents for the number of entities into a number of virtual documents, wherein the number of virtual documents comprises pages with data from the historical documents;
annotating positions for the data on the pages to generate a number of addresses, wherein each address represents a position of a datapoint from the data on a page from the pages;
generating historical contexts based on the ground truth data, the historical documents, and the number of addresses, wherein the historical contexts comprise metadata associated with datapoints from the data on the pages; and
creating a dynamic template for a current document for an entity from the number of entities, wherein the dynamic template comprises historical data from the historical documents and information extracted from the current document based on the historical contexts.

10. The computer system of claim 9, wherein the generating a dynamic template for a current document for an entity from the number of entities comprises:
generating a number of first clusters for each historical document from the historical documents, wherein each first cluster from the number of first clusters comprises information associated with a number of datapoints from data for a historical document;
generating a number of second clusters for the current document by matching information associated with the current document to the information associated with the number of first clusters; and
creating the dynamic template using information extracted based on the number of first clusters and the number of second clusters.

11. The computer system of claim 9, wherein the ground truth data comprises descriptions, values, and metadata associated with datapoints from the historical documents.

12. The computer system of claim 9, wherein the positions for datapoints on the pages comprises top coordinates, bottom coordinates, left coordinates, and right coordinates.

13. The computer system of claim 9, wherein each page from the pages comprises lines, tables, paragraphs, and metadata for each line based on the data from the historical documents.

14. The computer system of claim 9, wherein the positions for the data on the pages are annotated manually by users through user interface.

15. The computer system of claim 9, wherein the positions for the data on the pages are annotated autonomously based on the historical documents using a machine learning model.

16. The computer system of claim 9, wherein the number of virtual documents is stored in memory.

17. A computer program product comprising:
a set of one or more computer-readable storage media;
program instructions stored in the set of one or more storage media to perform operations comprising:
collecting, by a processor set, ground truth data and historical documents for a number of entities;
converting, by the processor set, physical documents for the number of entities into a number of virtual documents, wherein the number of virtual documents comprises pages with data from the historical documents;
annotating, by the processor set, positions for the data on the pages to generate a number of addresses, wherein each address represents a position of a datapoint from the data on a page from the pages;
generating, by the processor set, historical contexts based on the ground truth data, the historical documents, and the number of addresses, wherein the historical contexts comprise metadata associated with datapoints from the data on the pages; and
creating, by the processor set, a dynamic template for a current document for an entity from the number of entities, wherein the dynamic template comprises historical data from the historical documents and information extracted from the current document based on the historical contexts.

18. The computer program product of claim 17, wherein the generating, by the processor set, a dynamic template for a current document for an entity from the number of entities comprises:
generating, by the processor set, a number of first clusters for each historical document from the historical documents, wherein each first cluster from the number of first clusters comprises information associated with a number of data points from data for a historical document;
generating, by the processor set, a number of second clusters for the current document by matching information associated with the current document to the information associated with the number of first clusters; and
creating, by the processor set, the dynamic template using information extracted based on the number of first clusters and the number of second clusters.

19. The computer program product of claim 17, wherein the ground truth data comprises descriptions, values, and metadata associated with datapoints from the historical documents.

20. The computer program product of claim 17, wherein the positions for datapoints on the pages comprise top coordinates, bottom coordinates, left coordinates, and right coordinates.

21. The computer program product of claim 17, wherein each page from the pages comprises lines, tables, paragraphs, and metadata for each line based on the data from the historical documents.

22. The computer program product of claim 17, wherein the positions for the data on the pages are annotated manually by users through user interface.

23. The computer program product of claim 17, wherein the positions for the data on the pages are annotated autonomously based on the historical documents using a machine learning model.

24. The computer program product of claim 17, wherein the number of virtual documents is stored in memory.
